(19) United States
(12) Patent Application Publication
(10) Pub. No.: US 2003/0230210 A1
(43) Pub. Date: Dec. 18, 2003

(54) Rotary plural plate cylinders head

(76) Inventor: Avi-Ben Porat, Norwalk, CT (US)

Correspondence Address: MORGAN & FINNEGAN, L.L.P., 345 Park Avenue, New York, NY, 10154-0053, US

(21) Appl. No.: 10/174,201

(22) Filed: Jun. 17, 2002

(51) Int. Cl. B41F 13/44; B41F 7/08

(52) U.S. Cl. 101/486; 101/141; 101/216; 101/425

(57) ABSTRACT

A rotary printing press for printing on different width paper. The printing press utilizes multiple rotating plate cylinders of different width size housed in an independently rotating magazine which allows for printing on sheet fed or web paper without having to change printing modules or ink transfer cylinders. The multiple rotating cylinders of different width size are engaged with a continuous ink transfer device which transfers the ink from the imaged inked plate to the paper or printed substrate. This press may be utilized to print on both sides of the paper or printed substrate by combining two printing presses on either side of the paper or printed substrate.

### BACKGROUND OF THE INVENTION

1. Field of Invention

The present invention generally relates to a rotary printing press having multiple rotating cylinders housed in an independently rotating magazine and, more particularly, to a rotary printing press having multiple rotating cylinders of varying widths housed in an independently rotating magazine, which facilitates printing on different sized paper without requiring multiple presses or portable inserts or modules.

2. Description of Related Art

Rotary printing presses are well-known. In the rotary printing process, just four colored inks produce all printed colors in a graphic design. The four inks are the secondary colors (yellow, magenta, cyan) and black. Each ink is printed by a separate printing plate. Producing these plates involves two processes: color scanning and typesetting. Color scanning breaks the graphic design down into the three secondary colors and black, while typesetting converts text into print.

A color scanner breaks down the graphic design into four separate color images, or separations, which together will recreate the full-color graphic design. In each separation, the picture is broken up into many separate dots. A computer in the scanner controls the size of the dots, producing large dots where the ink must be dense and small dots in other parts of the separation. Breaking up the graphic design into varied-sized dots enables the printing plates to print any color at any intensity or shading.

A separate printing plate is made for each of the four colored inks and contains both the dot separation and any text for that color ink. Each plate is contoured so that it can be wrapped around a cylinder of a rotary printing press. In a web offset press, each of the four colored inks are sequentially applied to the web by the printing plate for that color ink so as to print the full-color graphic design and text on to the web.

Conventionally, in order to paint on paper of different width sizes, the user had to use separate presses each with printing cylinders of different widths. This method of printing is extremely inefficient. For example, the user must house multiple presses, but may not typically use the presses simultaneously. This means that while one press is printing on paper of a particular size, another press must sit idle if work is not available for its size. Having multiple presses capable of printing on paper of different sizes greatly increases efficiency by allowing each press to be utilized at any given time.

It is also well known that printing on different sized paper may be accomplished by utilizing a rotary printing press that has exchangeable printing cylinders of varying width. Exchangeable printing cylinders may be composites such as a plate cylinder or a blanket cylinder printing couple. In order to exchange a printing cylinder the user is typically required to slide the cylinder axially with respect to the cylinder shafts so that it may be removed and exchanged with a cylinder of a different width. Printing cylinders are extremely heavy. Consequently, the time and effort expended in exchanging the cylinders dramatically increases the make ready time.

Thus, there exists a need for a printing press which allows for printing on paper of different sizes that is compact, efficient, does not require portable inserts or modules, and requires minimum maintenance for reliable operation.

### SUMMARY OF THE INVENTION

The present invention solves these and other needs as apparent from the following description. The present invention may be utilized to print on any number of substrates including, but not limited to, sheet fed paper, web paper, and copolymer film. The present invention was developed to allow for fast efficient printing on different size paper by using a single rotary printing press that does not require portable inserts or modules.

One embodiment of the present invention features multiple rotating plate cylinders of varying width sizes that are housed in an independently revolving magazine. The particular plate cylinder being used at any given time is called the plate-on-duty or the plate-on-duty cylinder. This embodiment utilizes a fixed plate feeder, a fixed ink transfer device, an adjustable ink roller train system that can be engaged or adjusted into the plate-on-duty, and a fixed impression cylinder. The fixed ink transfer device may be a blanket cylinder or belt blanket.

The printing process begins when the desired image is imaged onto a printing plate. The printing plate is then wrapped around the plate-on-duty by the plate feeder. Another method of imaging the plate-on-duty is accomplished by spraying a coat of polymer directly on the plate-on-duty and directly imaging the plate. The magazine then rotates the plate-on-duty into position to receive the printing plate. After the printing plate has been wrapped around the plate-on-duty cylinder the revolving magazine rotates such that the plate-on-duty arrives in position to be both inked by the ink rollers and in contact the ink transfer device. Once in this position, the ink rollers are adjusted to ink the plate-on-duty. Then, the desired image becomes inked by rotating the plate-on-duty clockwise. Continuing to rotate the plate-on-duty clockwise once the desired image has been inked transfers the desired image to the ink transfer device that is rotating proportionately in the opposite direction, i.e. counterclockwise. Continuing to rotate the ink transfer device counterclockwise transfers the desired imaged to the paper by bringing the desired inked image into contact with the paper. An impression cylinder, located on the opposite side of the paper as the ink transfer device, is used to support and compress the paper so that the desired image may be transferred.

After the desired image has been printed or a certain number of images have been transferred or the job completed, the excess or residue ink and debris may be removed from the blanket cylinder by means of a blanket cleaner. Similarly, excess or residue ink may be removed from the plate cylinder by means of a plate cleaner. The image should then be changed from the plate-on-duty. This can be done by changing to a new imaged plate, or by using a direct-imaging (“DI”) system that imposes the new image on the press using a computer-to-plate system. The image contained on a plate cylinder can also be made by spraying a coat of polymer on the cylinder and directly imaging or burning that coated polymer on the plate cylinder. When the print job is accomplished the imaged coating is removed and new coat is applied.

In another embodiment of the present invention, the rotatable magazine includes multiple independently rotating plate cylinders that are coupled to corresponding rotating blanket cylinders. In other words, the rotating magazine houses both multiple couples of rotating plate cylinders of varying width in addition to corresponding multiple rotating blanket cylinders of corresponding varying width. This arrangement facilitates overlapping printing on varying width paper.

In yet another embodiment of the present invention, the rotary printing press may be utilized for two-sided paper printing by mounting an identical or substantially similar system one on either side of printed substrate. In this two-sided printing arrangement, each ink transfer device simultaneously acts as an impression cylinder for the opposing ink transfer device.

### BRIEF DESCRIPTION OF THE DRAWINGS

FIG. 1a is a perspective view of one embodiment of the printing press having multiple rotating cylinders of different width.

FIG. 1b is a perspective view of one embodiment illustrating the printing press having multiple rotating cylinders of different width where the plate-on-duty is in position to receive the printing plate.

FIG. 1c is a side view of one embodiment illustrating the printing press having multiple rotating cylinders of different width where the plate-on-duty is in position to transfer the inked image to the ink transfer device.

FIG. 1d is a side view of one embodiment illustrating the printing press where the ink transfer device is belt blanket type.

FIG. 2a is a perspective view of one embodiment of the printing press having a revolving magazine including multiple rotating cylinders of different width and multiple plate cylinders of different width.

FIG. 2b is a side view of one embodiment of the printing press having a revolving magazine including multiple rotating cylinders of different width and multiple plate cylinders of different width.

FIG. 3a is a perspective view of one embodiment of the printing press having multiple rotating cylinders of different width size utilized for two-sided printing.

FIG. 3b is a side view of one embodiment of the printing press having multiple rotating cylinders of different width size utilized for two-sided printing.

### DETAILED DESCRIPTION OF PREFERRED EMBODIMENTS

Turning now to the drawings, in which like numerals denote like components, there is illustrated various rotary printing press devices for printing on different size paper according to the present invention. It is understood that the device may be employed to print on various size substrate known in the art including sheet, web or copolymer.

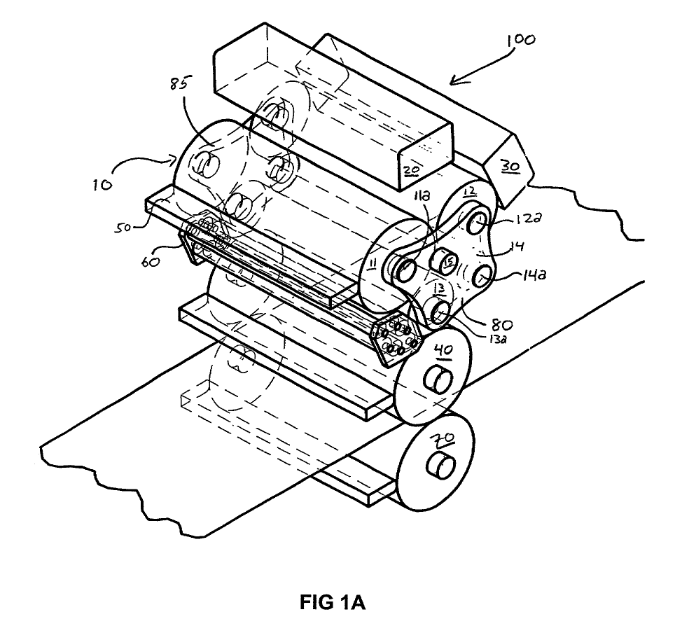

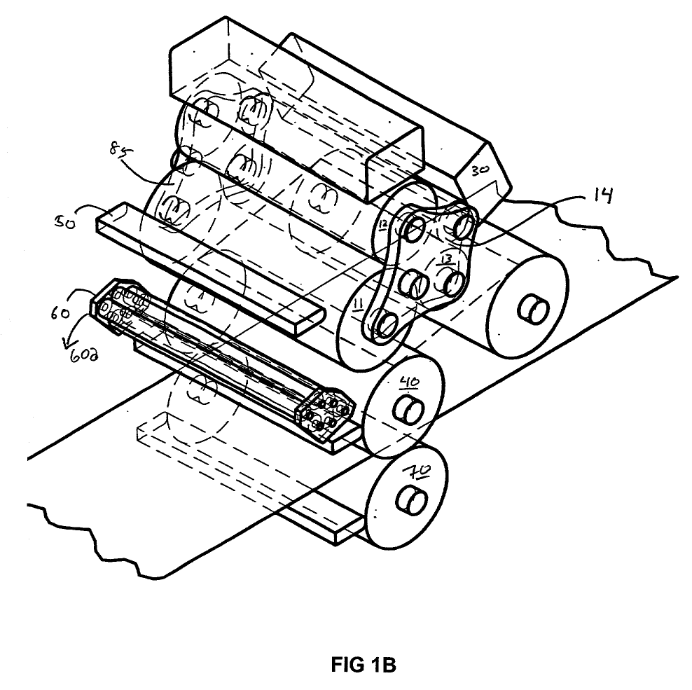

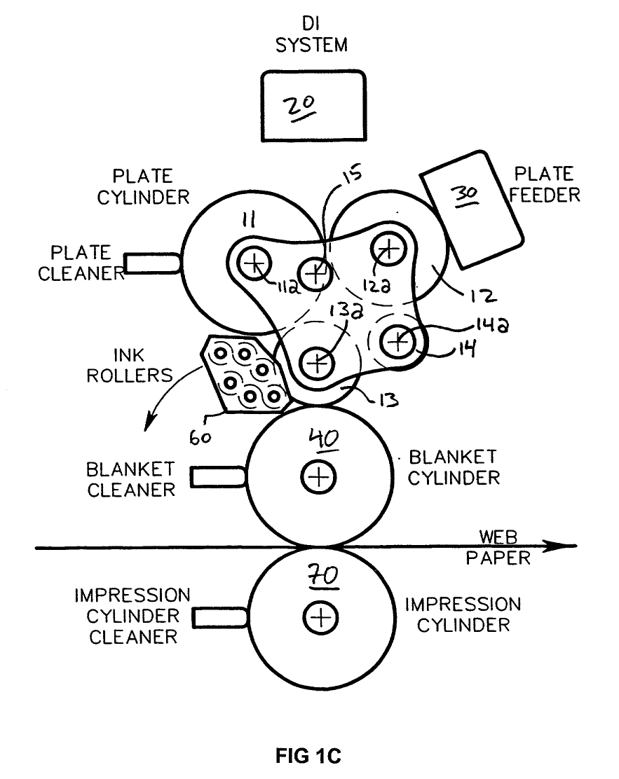

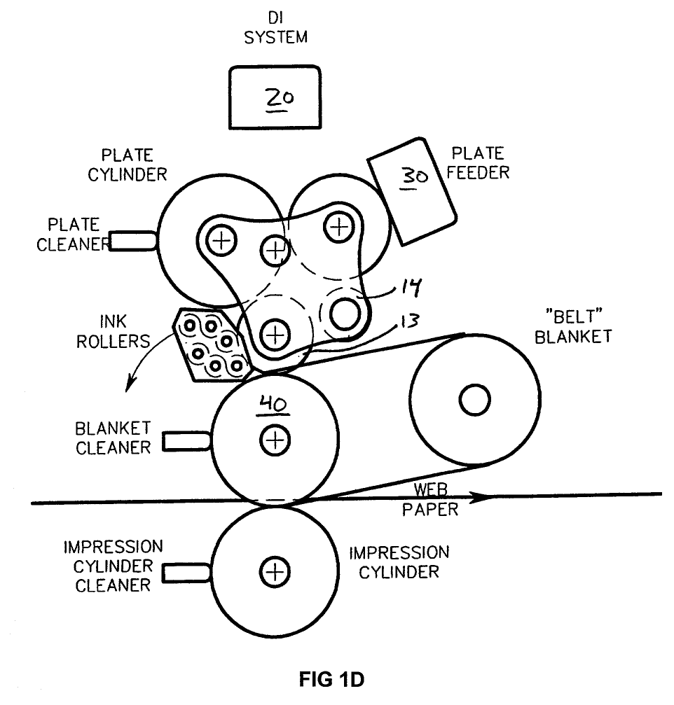

I. The Embodiment of FIG. 1a, FIG. 1b, FIG. 1c, and FIG. 1d

One specific embodiment will now be described with reference to FIGS. 1a, 1b, 1c, and 1d. FIG. 1a illustrates a printing press 100 for printing on multiple sized paper which includes a revolving magazine 10 of independently revolving variable width plate cylinders 11, 12, 13, 14. Magazine 10 rotates about a centrally located pivot pin 15 that is supported by a support frame (not shown). Each plate cylinder 11, 12, 13, 14 is free to independently rotate about its respective rotational axis, 11a, 12a, 13a, 14a. As shown in FIG. 1a, magazine 10 comprises a pair of connection plates 80, 85 located axially of plate cylinders 11, 12, 13, 14. A fixed distance (not shown) is maintained between the nip of each plate cylinder 11, 12, 13, 14 and centrally located pivot pin 15, such that when magazine 10 rotates, the desired plate cylinder may be brought into contact with DI system 20, plate feeder 30, and ink transfer device 40, as desired. Maintaining fixed distance allows plate feeder 30, DI system 20 and ink image transfer device 40 to remain fixed although these devices need not be fixed. Maintaining a fixed distance also enables plate cleaner 50 to remain fixed or angularly adjustable if such a cleaner is used.

A separate printing plate (not shown) is made for each of the four colored inks and contains both the dot separation and any text for that color ink. Each printing plate is contoured so that it can be wrapped around the plate-on-duty cylinder by the plate feeder 30.

The rotary printing process as described in the present invention begins when the desired image is imaged onto a printing plate (not shown). The printing plate is then wrapped around a particular plate cylinder depending on which sized paper is being printed upon. For example, plate cylinder 11 would typically be used for larger width printing while plate cylinder 14 would typically be used for smaller width printing. The term plate-on-duty is used to denote the particular plate cylinder that is being used for printing.

The desired plate-on-duty is moved into a position to receive the printing plate by rotating magazine 10 such that the desired plate-on-duty comes into contact with plate feeder 30. As can be seen in FIG. 1b, plate cylinder 13 is in position to receive the printing plate (not shown) from plate feeder 30. Because plate cylinder 13 is the plate cylinder being used for this particular print job it may also be termed the “plate-on-duty.” Once plate-on-duty 13 receives the printing plate from plate feeder 30, plate-on-duty 13 is moved into contact with ink imaged transfer device 40 by rotating magazine 10.

As illustrated by arrow 60a in FIG. 1b, ink rollers 60 are adjustable and may be brought into contact with each of the variable width plate cylinders 11, 12, 13, 14 depending upon which of the plate cylinders is the printing plate-on-duty. As illustrated in FIG. 1b, ink rollers 60 should be adjusted away while magazine 10 rotates. Once the plate-on-duty arrives in position to be inked, as shown in FIGS. 1a and 1c, ink rollers 60 are adjusted to come into contact with the plate-on-duty, i.e. plate cylinder 13. The plate-on-duty is then rotated so that the desired image becomes inked.

The desired image is then transferred from the plate-on-duty, i.e. plate cylinder 13, to fixed ink transfer device 40 by rotating ink transfer device 40 counterclockwise such that the inked image is transferred from the plate-on-duty to the ink transfer device 40. At any given time, only one of plate cylinders 11, 12, 13, 14 may be engaged with the ink transfer device 40. The desired image is finally transferred to the printed substrate by continuing to rotate ink transfer device 40 counterclockwise such that the inked image is transferred to the substrate. Impression cylinder 70 is used to provide support for ink transfer device 40 so that the desired image may accurately be transferred from the ink transfer device 40 to the printed substrate. As shown in FIGS. 1a, 1b and 1c, ink transfer device 40 may be of the blanket cylinder type. As shown in FIG. 1d, the ink transfer device 40 may be of the belt blanket type. Such system may require a continuous cleaning system in the event that the image does not overlap on the image transfer device.

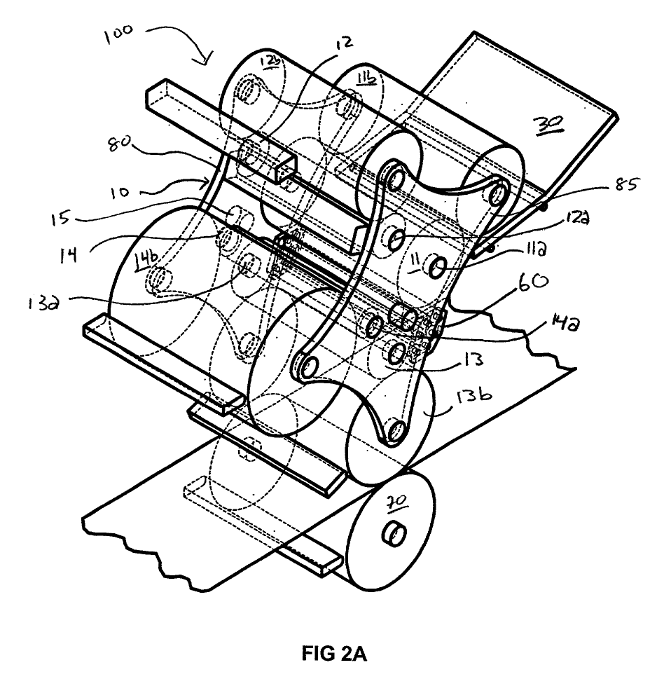

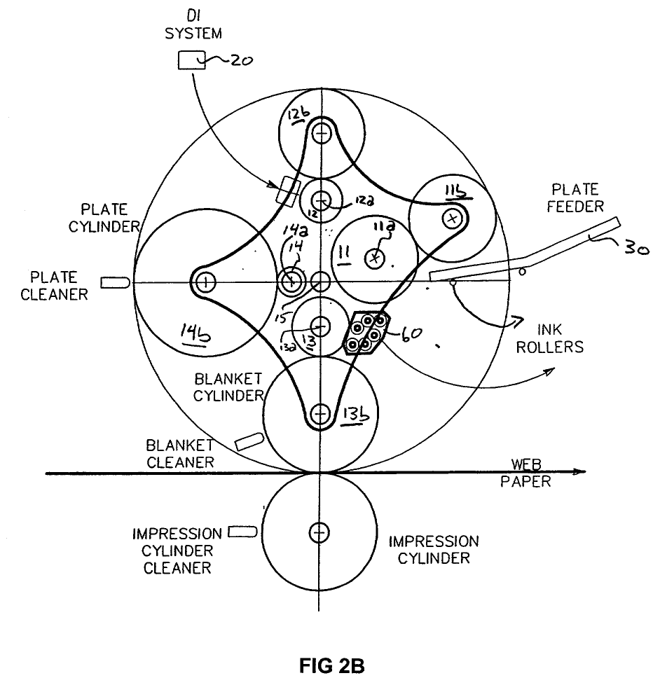

II. The Embodiment of FIG. 2a and FIG. 2b

One specific embodiment will now be described with reference to FIGS. 2a and 2b. FIG. 2a illustrates a rotary printing press 100 for printing on multiple sized paper which includes a revolving magazine 10 which houses varying width plate cylinders 11, 12, 13, 14 and rotating varying width blanket cylinders lib, 12b, 13b, 14b. Each plate cylinder is coupled with a corresponding blanket cylinder. For example, plate cylinder 11 and blanket cylinder 11b form a couple meaning that they are in contact with one another and rotate proportionately to one another in opposite directions. By forming couples, the user is able to not only print on different width paper but may also print overlapping repeatable images.

In this embodiment, magazine 10 rotates about a centrally located pivot pin 15 that is supported by a support frame (not shown). Each plate cylinder 11, 12, 13, 14 is free to rotate about its respective rotational axis, 11a, 12a, 13a, 14a proportionately with each corresponding blanket cylinder (or inked image transfer cylinder) 11b, 12b, 13b, 14b which rotate about their own respective rotational axis.

As shown in FIG. 2a, in one embodiment, magazine 10 is a pair of connection plates, 80 and 85, located axially of plate cylinders 11, 12, 13, 14 and blanket cylinders lib, 12b, 13b, 14b. A fixed distance is maintained between the nip of each blanket cylinder 11b, 12b, 13b, 14b and centrally located pivot pin 15. In this embodiment, DI system 20 and plate feeder 30 are not fixed in order to facilitate the rotation of magazine 10. Therefore, the plate-on-duty must be moved to a position and then either DI system 20 or plate feeder 30, depending upon which task is desired, must be adjusted to come into contact with the plate-on-duty. For example, as illustrated by the arrow in FIG. 2b, DI system 20 may be adjusted to direct-image plate cylinder 13 once plate cylinder 13 has arrived in the correct position. Additionally, the plate cylinder may be hinged such that it swings-out in order to facilitate the imaging process.

The rotary printing process as described in the present invention begins when the desired image is imaged onto a printing plate (not shown). Magazine 10 rotates so that the desired plate and blanket cylinder couple are positioned so that the plate cylinder, or plate-on-duty, may receive the printing plate from plate feeder 30. The printing plate is then wrapped around the plate-on-duty depending on which sized paper is being printed upon; alternately, the plate may be rotated out of the pattern to facilitate image processing. In an alternate embodiment of the present invention, a cylinder housing a plate film web that automatically advances the plate material may be used to eliminate the plate feeder 30.

In one embodiment of the present invention, the imaged plate-on-duty always has a corresponding blanket cylinder. As shown in FIG. 2b, plate cylinder 11 is in position to receive the printing plate thus becoming the plate-on-duty. Plate-on-duty 11 has coupled with it blanket cylinder 11b. Once plate-on-duty 11 receives the printing plate from plate feeder 30, magazine 10 revolves thereby moving plate-on-duty 11 to a position where ink rollers 60 may be brought into contact with the plate-on-duty. As illustrated by the arrow in FIG. 2b, ink rollers 60 are adjustable and may be brought into contact with each of the variable width plate cylinders 11, 12, 13, 14 depending upon which of the plate cylinders is going to be the plate-on-duty. Ink rollers 60 should be adjusted away while magazine 10 rotates. Once the plate-on-duty arrives in position to be inked, as shown in FIGS. 2a and 2b, ink rollers 60 are adjusted to come into contact with the plate-on-duty, i.e. plate cylinder 1. The plate-on-duty is then rotated so that the desired image becomes inked.

Continually rotating plate cylinder 11 transfers the desired image from the plate-on-duty, i.e. plate cylinder 11, to fixed ink transfer device lib. At any given time, only one of plate cylinders 11, 12, 13, 14 may be engaged with the ink rollers 60. The desired image is finally transferred to the printed substrate by continuing to rotate ink transfer device 11b counterclockwise such that the inked image is transferred to the paper. Impression cylinder 70 is used to provide support for ink transfer device so that the desired image may accurately be transferred from the ink transfer device to the printed paper

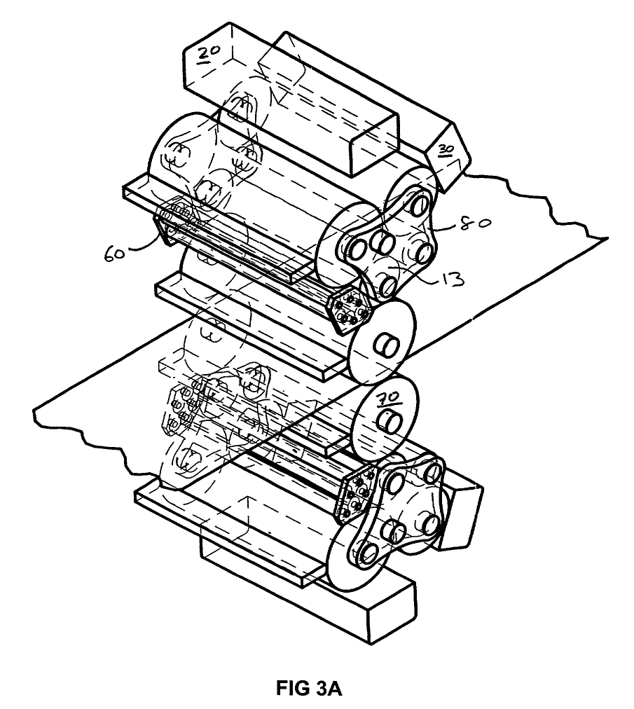

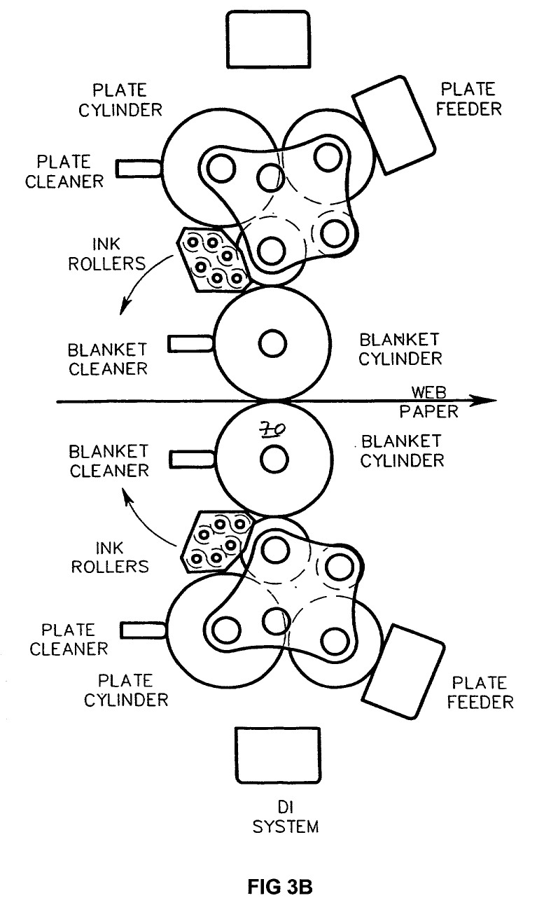

Either of the above embodiments may be utilized to print on both sides of different width paper. As illustrated in FIGS. 3a and 3b, impression cylinder 70 is replaced by a mirror image rotary printing apparatus substantially similar the device as described in this invention. In this two-sided printing arrangement, each ink transfer device simultaneously acts as an impression cylinder for the opposing ink transfer device.

In one embodiment of the present invention, printing jobs can be planned such that plates are used sequentially. For instance, during printing on a first plate-on-duty, a second plate on duty may be imaged and prepared for printing. Coordination of this type eliminates or minimizes make-ready time between jobs with different size paper.

It is also understood that the above description is only representative of illustrative examples of embodiments and implementations. For the reader's convenience, the above description has focused on a representative sample of all possible embodiments, a sample that teaches the principles of the invention. Other embodiments may result from a different combination of portions of different embodiments. The description has not attempted to exhaustively enumerate all possible variations.

Alternate embodiments may not have been presented for a specific portion of the invention. Some alternate embodiments may result from a different combination of described portions, or other undescribed alternate embodiments may be available for a portion. This is not to be considered a disclaimer of those alternate embodiments. It is recognized that many of those undescribed embodiments are within the literal scope of the following claims, and others are equivalent.

What is claimed is:

1. A rotary printing press for printing a desired image on different width sized substrate comprising:
a plate feeder for wrapping an imaged printing plate to one of a plurality of independently rotating plate cylinders wherein the plurality of plate cylinders vary in width and are housed in an independently rotating magazine wherein the magazine rotates about a centrally located pivot point such that a fixed distance is maintained between the nip of each of the plurality of plate cylinders and the center of the magazine;
a support frame for rotatably supporting the magazine;
an ink train that may be adjusted to ink the imaged printing plate wherein the imaged printing plate is located on one of the plurality of plate cylinders;
an ink transfer device for receiving the desired image from the inked imaged printing plate and then printing the desired image onto the substrate wherein the opposing side of the paper is supported by an impression cylinder.

2. The rotary printing press of claim 1, wherein the ink transfer device is a blanket cylinder.

3. The rotary printing press of claim 1, wherein the ink transfer device is a belt-blanket cylinder couple.

4. The rotary printing press of claim 1, the press further comprises a direct-imaging system for imaging the printing plate with the image.

5. The rotary printing press of claim 4, wherein the direct-imaging system is fixed.

6. The rotary printing press of claim 1, the press further comprises a plate cleaning system for cleaning the plurality of plate cylinders.

7. The rotary printing press of claim 6, wherein the plate cleaning system is fixed.

8. The rotary printing press of claim 1, the press further comprises an ink transfer device cleaning system for cleaning the ink transfer device.

9. The rotary printing press of claim 1 wherein the plate feeder is rotatably mounted on said printing press.

10. The rotary printing press of claim 1, the press further comprises an impression cleaning system for cleaning the impression cylinder.

11. The rotary printing press of claim 10, wherein the impression cleaning system is fixed.

12. A rotary printing press for printing a desired image on different width sized paper comprising:
a plate feeder for wrapping an imaged printing plate to one of a plurality of independently rotating plate cylinders wherein each of the plurality of plate cylinders is coupled with a corresponding plurality of blanket cylinders thereby forming a plurality of plate and blanket cylinder couples;
a rotating magazine that houses the plurality of plate and blanket cylinder couples wherein the magazine independently rotates about a centrally located pivot point such that a fixed distance is maintained between the nip of each blanket cylinder and the center of the magazine when the magazine rotates;
a support frame for rotatably supporting the magazine;
an ink train that may be adjusted to ink the imaged printing plate wherein the imaged printing plate is located on one of the plurality of plate cylinders wherein the desired image is transferred from the imaged plate cylinder to its coupled blanket cylinder which then transfers the desired image to the substrate;
an impression cylinder for supporting the substrate such that the desired image may be transferred from the blanket cylinder to the substrate.

13. The rotary printing press of claim 12, wherein the plurality of plate cylinders vary in width.

14. The rotary printing press of claim 13, the press further comprises a direct-imaging system for imaging the printing plate with the image.

15. The rotary printing press of claim 14, wherein the direct-imaging system is adjustable.

16. The rotary printing press of claim 13, the press further comprises a plate cleaning system for cleaning the plurality of plate cylinders.

17. The rotary printing press of claim 16, wherein the plate cleaning system is adjustable.

18. The rotary printing press of claim 13, the press further comprises a blanket cleaning system for cleaning the plurality of blanket cylinders.

19. The rotary printing press of claim 18, wherein the blanket cleaning system is fixed.

20. The rotary printing press of claim 13, the press further comprises an impression cleaning system for cleaning the impression cylinder.

21. The rotary printing press of claim 20, wherein the impression cleaning system is fixed.

22. A method of printing a desired image on paper of different widths without requiring multiple presses or portable inserts or modules comprising the steps of;
feeding an imaged printing plate onto one of a plurality of independently rotating plate cylinders wherein the plurality of plate cylinders are housed in an independently rotating magazine wherein the magazine rotates about a centrally located pivot point such that a fixed distance is maintained between the nip of each of the plurality of plate cylinders and the center of the magazine;
rotating the magazine so that the imaged plate cylinder is in a position to be both inked by an adjustable ink roller and to transfer the inked image to the ink transferring device;
inking the imaged plate cylinder thereby creating an inked image;
transferring the inked image from the plate cylinder to the ink transfer device;
supporting the paper by means of an impression cylinder located on the opposing side of the paper from the ink transferring device;
printing the desired image by transferring the inked image from the ink transferring device onto the paper.
